(19) United States
(12) Patent Application Publication
(10) Pub. No.: US 2021/0139236 A1
(43) Pub. Date: May 13, 2021

(54) Systems, Devices, and/or Methods for Animal Proof Garbage Can Locks

(71) Applicant: Patrick Hanrahan, Earlysville, VA (US)

(72) Inventor: Patrick Hanrahan, Earlysville, VA (US)

(21) Appl. No.: 17/092,302

(22) Filed: Nov. 8, 2020

Related U.S. Application Data
(60) Provisional application No. 62/931,991, filed on Nov. 7, 2019.

(51) Int. Cl. B65F 1/16

(52) U.S. Cl. CPC B65F 1/1615; B65F 2210/148

(57) ABSTRACT

Certain exemplary embodiments can provide a system that comprises locking device. The locking device comprises a strap, a two piece buckle, and a pair of fasteners. The strap comprises a first segment and a second segment. Each of the first segment and the second segment comprises a first end and a second end. The first end of each of the first segment and the second segment defines an aperture. The locking device is constructed to couple a lid of a garbage can to a body of the garbage can.

### CROSS-REFERENCES TO RELATED APPLICATIONS

This application claims priority to, and incorporates by reference herein in its entirety, pending U.S. Provisional Patent Application Ser. No. 62/931,991 (Attorney Docket No. 1490-01), filed Nov. 7, 2019.

### BRIEF DESCRIPTION OF THE DRAWINGS

A wide variety of potential practical and useful embodiments will be more readily understood through the following detailed description of certain exemplary embodiments, with reference to the accompanying exemplary drawings in which:

FIG. 1 is a photograph of a perspective view of an exemplary embodiment of a system, 1000;

FIG. 2 is a photograph of a perspective view of an exemplary embodiment of a system, 2000;

FIG. 3 is a photograph of a perspective view of an exemplary embodiment of a system, 3000; and

FIG. 4 is a photograph of a perspective view of a can lock, 4000.

### DETAILED DESCRIPTION

Certain exemplary embodiments provide a locking device for attaching to a garbage can to stop bears, raccoons or other animals from getting to the contents of the can. The locking device also stops garbage can covers from coming off due to high winds.

Certain exemplary embodiments can provide a system that comprises locking device. The locking device comprises a strap, a two piece buckle, and a pair of fasteners. The strap comprises a first segment and a second segment. Each of the first segment and the second segment comprises a first end and a second end. The first end of each of the first segment and the second segment defines an aperture. The locking device is constructed to couple a lid of a garbage can to a body of the garbage can

The locking device comprises webbing straps, buckles, and fasteners. The fasteners can comprise either screws, rivets, and/or nuts and bolts, etc. The locking device is used in the securing of various garbage receptacle lids.

Certain exemplary embodiments can be used with rolling cart residential and commercial garbage containers with hinged lids. Certain exemplary embodiments can be utilized to lock non-hinged lids.

Often, garbage cans is secured is with an elastic cord. These cords do not fully secure the lid. Such cords can hold a degree of tension, which when released can have a potential to injure a garbage can owner or trash collector. In addition such cords can take multiple hands to secure the garbage can. Other securements for garbage can lids comprise hasp locks, which can be relatively difficult to install and to use on a daily basis.

Certain exemplary embodiments utilize a set of web straps and buckles. Ends of the web straps are secured to the top and side (e.g., front) of the container. The web straps are short enough and installed with minimal give to allow the ease of closing the buckles, while not allowing enough room for an animal such as a bear to gain enough leverage to open the lid.

FIG. 1 is a photograph of a perspective view of an exemplary embodiment of a system 1000, which comprises a garbage can 1100, a first locking device 1200, and a second locking device 1300. Coupling first locking device 1200 and/or second locking device 1300 to garbage can 1100 allows a user to secure a lid 1120 to a body 1140 of garbage can 1100.

FIG. 2 is a photograph of a perspective view of an exemplary embodiment of a system 2000, which comprises a garbage can 2100, a first locking device 2200, and a second locking device 2300. FIG. 2 illustrates an exemplary spacing of first locking device 2200, and second locking device 2300 on garbage can 2100.

FIG. 3 is a photograph of a perspective view of an exemplary embodiment of a system 3000, which comprises a garbage can 3100, and a locking device 3200. FIG. 3 provides a close-up view of, locking device 3200 coupled to garbage can 3100.

FIG. 4 is a photograph of a perspective view of a locking device 4000, which comprises a strap 4100, a two piece buckle 4200, a pair of apertures 4300, and a pair of fasteners 4400. In certain exemplary embodiments, strap 4100 can comprise polypropylene or a material of equal or greater strength. In certain exemplary embodiments, strap 4100 and/or two piece buckle 4200 can have tensile strengths of 1300 lbs or greater. Pair of grommets 4320 can provide strength to resist removal by tearing by an animal such as a large bear. Pair of fasteners 4400 engage with a garbage can via pair of apertures 4300. In the illustrated embodiment, pair of fasteners 4400 are hex head cap screws that are coupled to the garbage can via threaded hex nuts.

Certain exemplary embodiments can provide a system that comprises locking device 4000. Locking device 4000 comprises strap 4100, two piece buckle 4200, and a pair of fasteners 4400. Strap 4100 comprises a first segment 4120 and a second segment 4140. Each of first segment 4120 and second segment 4140 comprises a first end (first segment first end 4110 and second segment first end 4150) and a second end (first segment second end 4130 and second segment second end 4160). The first end of each of first segment 4120 and second segment 4140 define apertures 4300. Locking device 4000 is constructed to couple a lid (see lid 1120 of FIG. 1) of a garbage can (see garbage can 1100 of FIG. 1) to a body (see body 1140 of FIG. 1) of the garbage can (see garbage can 1100 of FIG. 1).

A first piece 4220 of two piece buckle 4200 can be fixedly coupled to first segment second end 4130. A second piece 4240 of two piece buckle 4200 can be fixedly coupled to second segment second end 4160.

A first fastener 4420 of pair of fasteners 4400 is constructed to couple the first segment first end 4110 to a lid of a garbage can (see garbage can 1100 of FIG. 1). The second fastener 4440 of pair of fasteners 4400 is constructed to couple second segment first end 4150 to a body (body 1140 of FIG. 1) of the garbage can (see garbage can 1100 of FIG. 1).

The buckle can be a dual side release buckle as illustrated in locking device 4000.

One of pair of grommets 4320 can be coupled to each of: (1) first segment first end 4110 to reinforce an aperture defined by first segment first end 4110; and (2) second segment first end 4150 to reinforce an aperture defined by second segment first end 4150.

Locking device 4000 can be one of a plurality of locking devices securing the lid (see lid 1120 of FIG. 1) of the garbage can (see garbage can 1100 of FIG. 1).

### Definitions

When the following terms are used substantively herein, the accompanying definitions apply. These terms and definitions are presented without prejudice, and, consistent with the application, the right to redefine these terms during the prosecution of this application or any application claiming priority hereto is reserved. For the purpose of interpreting a claim of any patent that claims priority hereto, each definition (or redefined term if an original definition was amended during the prosecution of that patent), functions as a clear and unambiguous disavowal of the subject matter outside of that definition.
a—at least one.
activity—an action, act, step, and/or process or portion thereof
adapter—a device used to effect operative compatibility between different parts of one or more pieces of an apparatus or system.
and/or—either in conjunction with or in alternative to.
apparatus—an appliance or device for a particular purpose.
associate—to join, connect together, and/or relate.
body—a largest or principal part of an object.
buckle—a fastening that is constructed to releasably couple two loose ends via a catch.
can—is capable of, in at least some embodiments.
comprising—including but not limited to.
configure—to make suitable or fit for a specific use or situation.
connect—to join or fasten together.
constructed to—made to and/or designed to.
coupling—to join in some fashion.
coupleable—capable of being joined, connected, and/or linked together.
define—to establish the outline, form, or structure of
determine—to obtain, calculate, decide, deduce, and/or ascertain.
device—a machine, manufacture, and/or collection thereof.
dual side release buckle—a fastening that is constructed to releasably couple two loose ends via receiver coupled to one of the loose ends that engages with a two edged clip coupled to the other of the loose ends. The two edged clip is released from the receiver application of pressure to each edge of the two edged clip.
end—a most extreme part of an object.
fastener—one (or more) restraints that attach to, extend through, penetrate, and/or hold something. For example, a fastener can be one (or more) bolt and nut assembly, rivet, weldment, nail, screw, peg, staple, clip, buckle, clasp, clamp, hook and loop assembly, adhesive, and/or plastic push rivet, etc.
fixedly—coupled so as to be firm and substantially not nondestructibly removable.
garbage can—a container constructed to receive trash.
generate—to create, produce, give rise to, and/or bring into existence.
grommet—an eyelet that reinforces an opening to reduce damage exposure to material surrounding the eyelet.
install—to connect or set in position and prepare for use.
lid—a movable cover for an opening of a garbage can.
lock—to fasten.
may—is allowed and/or permitted to, in at least some embodiments.
method—a process, procedure, and/or collection of related activities for accomplishing something.
piece—a part of a larger device or system.
plurality—the state of being plural and/or more than one.
predetermined—established in advance.
provide—to furnish, supply, give, and/or make available.
receive—to get as a signal, take, acquire, and/or obtain.
repeatedly—again and again; repetitively.
secure—to firmly couple something.
segment—a separate piece of something.
set—a related plurality.
store—to place, hold, and/or retain.
substantially—to a great extent or degree.
support—to bear the weight of, especially from below.
system—a collection of mechanisms, devices, machines, articles of manufacture, processes, data, and/or instructions, the collection designed to perform one or more specific functions.
via—by way of and/or utilizing.

### Note

Still other substantially and specifically practical and useful embodiments will become readily apparent to those skilled in this art from reading the above-recited and/or herein-included detailed description and/or drawings of certain exemplary embodiments. It should be understood that numerous variations, modifications, and additional embodiments are possible, and accordingly, all such variations, modifications, and embodiments are to be regarded as being within the scope of this application.

Thus, regardless of the content of any portion (e.g., title, field, background, summary, description, abstract, drawing figure, etc.) of this application, unless clearly specified to the contrary, such as via explicit definition, assertion, or argument, with respect to any claim, whether of this application and/or any claim of any application claiming priority hereto, and whether originally presented or otherwise:
there is no requirement for the inclusion of any particular described or illustrated characteristic, function, activity, or element, any particular sequence of activities, or any particular interrelationship of elements;
no characteristic, function, activity, or element is “essential”;
any elements can be integrated, segregated, and/or duplicated;
any activity can be repeated, any activity can be performed by multiple entities, and/or any activity can be performed in multiple jurisdictions; and
any activity or element can be specifically excluded, the sequence of activities can vary, and/or the interrelationship of elements can vary.

Moreover, when any number or range is described herein, unless clearly stated otherwise, that number or range is approximate. When any range is described herein, unless clearly stated otherwise, that range includes all values therein and all subranges therein. For example, if a range of 1 to 10 is described, that range includes all values therebetween, such as for example, 1.1, 2.5, 3.335, 5, 6.179, 8.9999, etc., and includes all subranges therebetween, such as for example, 1 to 3.65, 2.8 to 8.14, 1.93 to 9, etc.

When any claim element is followed by a drawing element number, that drawing element number is exemplary and non-limiting on claim scope. No claim of this application is intended to invoke paragraph six of 35 USC 112 unless the precise phrase “means for” is followed by a gerund.

Any information in any material (e.g., a United States patent, United States patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such material is specifically not incorporated by reference herein.

Accordingly, every portion (e.g., title, field, background, summary, description, abstract, drawing figure, etc.) of this application, other than the claims themselves, is to be regarded as illustrative in nature, and not as restrictive, and the scope of subject matter protected by any patent that issues based on this application is defined only by the claims of that patent.

What is claimed is:

1. A system comprising:
a locking device, the locking device comprising:
a strap, the strap comprising a first segment and a second segment, each of the first segment and the second segment comprising a first end and a second end, the first end of each of the first segment and the second segment defining an aperture;
a two piece buckle, a first piece of the two piece buckle fixedly coupled to the first segment second end, a second piece of the two piece buckle fixedly coupled to the second segment second end;
and a pair of fasteners, a first fastener of the pair of fasteners constructed to couple the first segment first end to a lid of a garbage can, a second fastener of the pair of fasteners constructed to couple the second segment first end to a body of the garbage can.

2. The system of claim 1, wherein:
the two piece buckle is a dual side release buckle.

3. The system of claim 1, further comprising:
a grommet is coupled to the first segment first end to reinforce the aperture of the first segment first end.

4. The system of claim 1, further comprising:
the garbage can.

5. The system of claim 1, wherein:
the locking device is one of a plurality of locking devices securing the lid of the garbage can.
